(19) United States
(12) Patent Application Publication
(10) Pub. No.: US 2002/0196239 A1
(43) Pub. Date: Dec. 26, 2002

(54) Joy-dial for providing input signals to a device

(76) Inventor: Siew Fei Lee, Singapore (SG)

Correspondence Address: HEWLETT-PACKARD COMPANY, Intellectual Property Administraion, P.O. Box 272400, Fort Collins, CO, 80527-2400, US

(21) Appl. No.: 09/892,312

(22) Filed: Jun. 26, 2001

(51) Int. Cl. G09G 5/00

(52) U.S. Cl. 345/184

(57) ABSTRACT

The invention relates to a joy-dial for providing input signals to a device. The device would typically include mobile devices such as a portable digital assistant (PDA), hand phones and wireless handsets. With all of these devices it is important to maximise input possibility by the user, whilst minimising the size of the componentry. The joy-dial is rotatable so as to provide additional inputs

### FIELD OF THE INVENTION

The present invention relates to a joy-dial for providing input signals to a device. The device would typically include mobile devices such as portable digital assistants (PDA), hand phones and wireless handsets.

### BACKGROUND OF THE INVENTION

Traditionally, the method of providing an input signal to mobile devices of the type described above have included touch/digitisers, keyboard/buttons and directional motion detectors. These input methods translate user inputs into the device so as to carry out various tasks. One example of such a task is to key in the characters for a word processing application.

There is an ever-increasing demand to miniaturise hand held devices such as PDA's. As a consequence of this demand there is generally a restriction in the size and number of buttons or devices which can be retained for the user interface. However, although it is extremely desirable to reduce the size of these devices it is also important to maintain the “user friendly” nature of the device and to ensure that it is possible to input all required information. The present invention seeks to address the abovementioned problems.

### SUMMARY OF THE INVENTION

According to a first aspect of the present invention there is provided a joy-dial for providing input signals to a device, said joy-dial having a first and a second x-axis input position, a first and a second y-axis input position, and a first and a second directional input position, a joy pad, an elastically deformable diaphragm located below the joy pad corresponding to each of the x-axis and y-axis inputs, a contact located below and associated with each of the diaphragms and arranged so that pressure applied to the joy pad at one of the x- or a y-axis input positions results in deformation of the corresponding diaphragm and closure of the associated contact, and wherein the joy-dial further includes a first and a second directional contact, said first and second directional contacts being arranged so that they are closed upon movement of the joy dial in a first or a second direction respectively.

Preferably, the first and second directional inputs are closed by respective anti-clockwise and clockwise rotation of the joy pad about a z-axis. Preferably, rotation of the joy pad is simultaneously accompanied with a downward pressure applied to the joy pad by the user.

Preferably, the joy-dial also includes a diagonal input between each of the first y-axis input and the second x-axis input, the second x-axis input and second y-axis input, the second y-axis input and the first x-axis input and the first x-axis input and the first y-axis input.

Preferably, the joy-dial also includes a central input. The central input would typically be used as the enter or accept input.

The joy pad is preferably marked to indicate the position of each of the x-axis, y-axis, diagonal and central inputs. The marking may also indicate to the user how to operate each of the inputs. The joy-dial may also be marked so as to indicate how to operate the first and second directional inputs.

According to a second aspect of the present invention there is provided an information device having at least one joy-dial, said joy-dial being arranged to provide input signals to the device, said joy-dial having a first and a second x-axis input position, a first and a second y-axis input position, and a first and a second directional input position, a joy pad, an elastically deformable diaphragm located below the joy pad corresponding to each of the x-axis and y-axis inputs, a contact located below and associated with each of the diaphragms and arranged so that pressure applied to the joy pad at one of the x- or a y-axis input positions results in deformation of the corresponding diaphragm and closure of the associated contact, and wherein the joy-dial further includes a first and a second directional contact, said first and second directional contacts being arranged so that they are closed upon movement of the joy dial in a first or a second direction respectively.

Preferably, the information device also includes a microprocessor which is arranged to detect the closure of any one of the contacts and to interpret such as a logical state change. The device preferably also includes an operating system which is arranged to be informed by the microprocessor of any logical state change.

Biasing means, preferably in the form of at least one spring, is provided to restore the joy-dial to a home position once the user removes a force necessary to move the joy pad in the first or second direction. The home position is a position in which none of the contacts of the joy pad are activated.

### BRIEF DESCRIPTION OF THE DRAWINGS

Embodiments of the invention will now be described, by way of example only, with reference to the accompanying drawings in which:

FIG. 1 is a perspective of a personal digital assistant (PDA) incorporating a joy dial in accordance with an embodiment of the invention.

FIG. 2 is a schematic illustration of a joy pad of a joy-dial in accordance with an embodiment of the invention and showing inputs A, B, C and D.

FIG. 3 illustrates the joy pad of FIG. 2 with diagonal inputs E, F, G and H.

FIG. 4 is view similar to FIGS. 2 and 3 but showing rotational input I and J and an enter input K.

FIG. 5 is an assembly view of a joy-dial in accordance with an embodiment of the invention.

FIG. 6 is a schematic side view of a diaphragm and its associated contact.

FIG. 7 is a schematic illustration of the mechanical construction of the joy-dial together with an electrical connection to a microprocessor.

FIG. 8 is an assembly view of a joy-dial in accordance with another embodiment of the invention.

### DETAILED DESCRIPTION OF THE PREFERRED EMBODIMENT

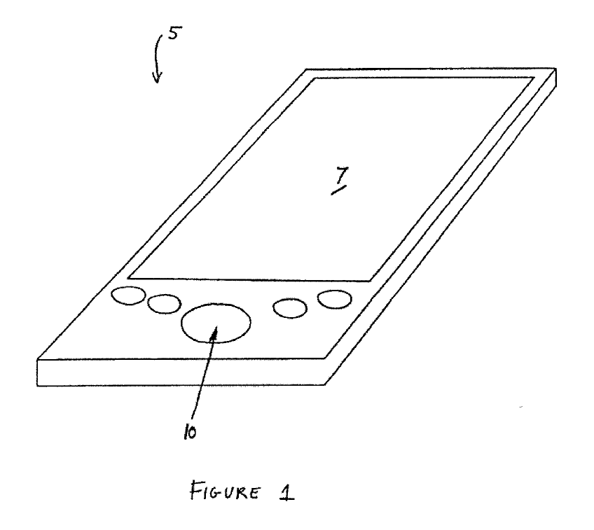

FIG. 1 illustrates a personal digital assistant or device 5 having a screen 7 and incorporating a joy dial 10 in accordance with an embodiment of the invention.

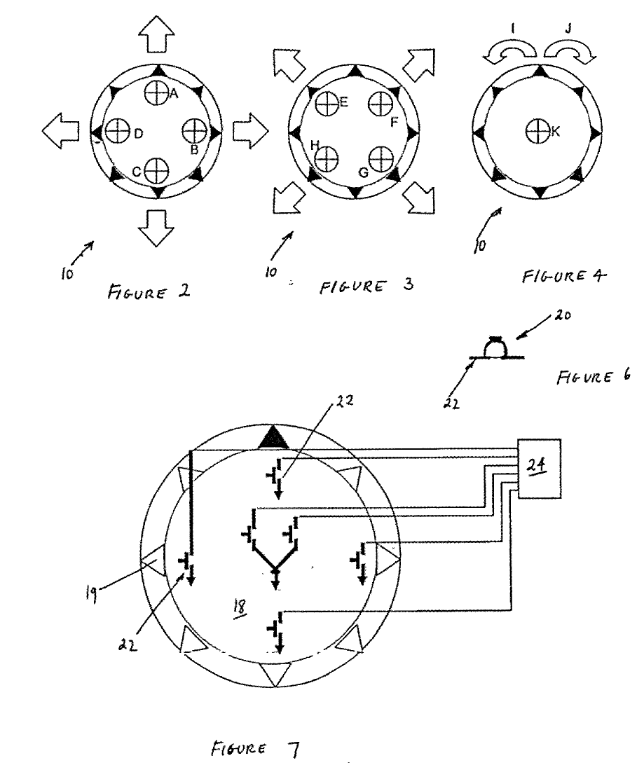

FIGS. 2 to 4 schematically illustrate the various inputs of the joy-dial 10 in accordance with an embodiment of the invention. The joy-dial 10 has a first and a second x-axis inputs D, B, first and second y-axis inputs A, C and first and second directional inputs I and J. The directional inputs I, J are operated in this embodiment by applying a rotational movement to the joy-dial about a z-axis. The z-axis extends substantially perpendicular to the planar surface of the joy-dial 10. As illustrated in FIG. 3, the joy-dial 10 also includes diagonal inputs E, F, G, H. In addition, the joy-dial 10 includes a centrally located input K. The centrally located input K would typically be used as the enter or accept input.

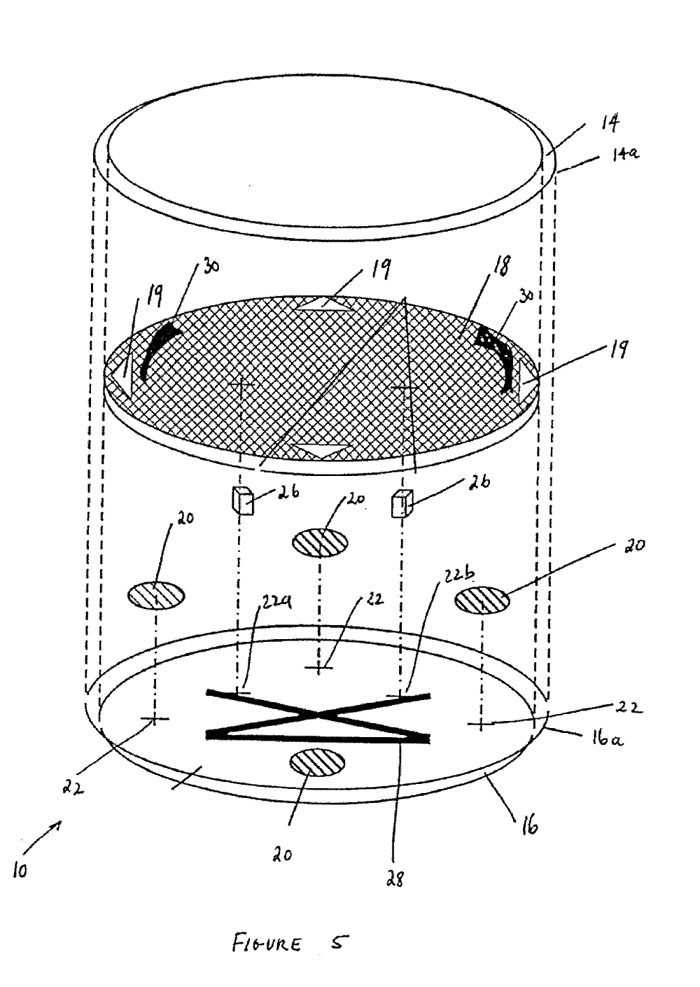

As illustrated in FIG. 5, in one form, the joy-dial 10 is formed from an upper cage or ring 14, a base 16 and a joy pad 18 arranged to be mounted there between. The base 16 is attached to the device 5 or to the printed circuit board (PCB) of such a device 5. The upper ring 14 is arranged to be connected to the base 16 and to locate the joy pad 18 there between. The upper ring 14 and base 16 are sized so that they can retain there between the joy pad 18. As illustrated in FIG. 5, the upper ring 14 is tapered so that it has a lower diameter larger than its upper diameter. The base 16 is tapered so that its upper diameter is larger than its lower diameter. The lower edge 14a of the upper ring 14 is therefore arranged to be engaged with the upper edge 16a of the base 16 using an adhesive or other locking mechanism.

The joy pad 18 has a diameter just greater than the upper diameter of the upper ring 14 and the lower diameter of the base 16 so that the upper ring 14 retains the joy pad 18 between itself and the base 16. However, rotational movement of the joy pad 18 is possible because of the difference in diameter of the joy pad 18 and the lower edge 14a and upper edge 16a of the upper ring 14 and base 16 respectively. The height of the upper ring 14 and base 16 is such that there is sufficient gap there between to allow up and down movement of the joy pad 18. This movement will be described in more detail subsequently.

As explained previously, the joy pad 18 is mounted within the base 16 and a ring shaped cage 14 for rotational movement so as to enable the anti-clockwise and clockwise rotation about the z-axis required for the first and second directional inputs I, J. The joy pad 18 is also arranged so that it can move towards the base 16 when it is pressed by the user.

As shown in the Figures, the joy pad 18 is substantially circular in shape, although other shaped pads are envisaged. The joy pad 18 is preferably made from a plastics material such as polycarbonate and may include grid like patterns on its upper surface so as to enhance grip thereof by the user's finger when depressing or rotating the joy pad 18. The joy pad 18 also includes a pair of thumb rails 30 which are fused onto or integrally formed with the upper surface of the joy pad 18. The thumb rails 30 are located respectively on the left and right side of the joy pad 18 adjacent the periphery of the joy pad 18. The function of the thumb rails 30 is to aid the user to rotate the joy pad 18 in a clockwise or anticlockwise direction by allowing the user to easily apply a “forward up” push or rotation on either the left or right thumb rail 30 respectively.

The joy pad 18 is marked with input positions 19 for each of the x-axis, y-axis, diagonal and central inputs. The joy pad 18 is also preferably marked to identify the first and second directional inputs. The joy pad 18 may also be marked so as to inform the user how to activate each input. In one preferred embodiment, triangular shaped markers 19 are included on the joy-pad 18 to indicate the positioning of each of the inputs A-G.

Located beneath the joy-pad 18 and in contact therewith are four elastically deformable diaphragms 20. Each diaphragm 20 is dome shaped and will conduct electricity when depressed. One diaphragm 20 is positioned below each of the input positions A, B, C and D. Positioned below each elastically deformable diaphragm 20 and in contact therewith is an associated mechanical contact 22. (FIG. 5 only illustrates the positioning of the contacts 22 and not the contacts 22 themselves.) An example of one of the diaphragms 20 and its associated contact 22 is shown in FIG. 6.

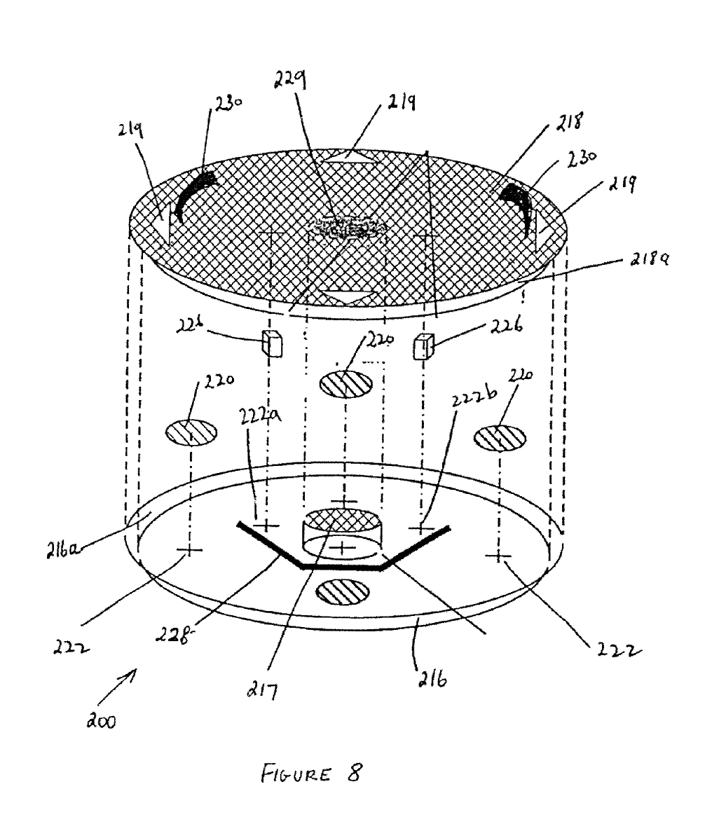

Each mechanical contact 22 is connected to an electrical circuit which includes a micro processor 24 or the like. This connection is illustrated, somewhat schematically, in FIG. 7 and will be described in more detail below.

When a user presses one of the input positions 19 on the joy pad 18, for example input position A, the diaphragm 20 under input A is elastically deformed so that it conducts electricity and closes the mechanical contact 22 positioned there beneath.

Diagonal inputs E-H and input K do not have a diaphragm 20 positioned there beneath. Instead, pressure applied to any one of the diagonal input positions E-H results in deformation of the diaphragms 20 below the adjacent x- and y-axis inputs. Consequently, this results in closure of both of the associated mechanical contacts 22. For example, if the user presses input position E on the joy pad 18, the diaphragms 20 under input positions A and D deform to conduct electricity and close both of their associated contacts 22. When both of the contacts 22 are closed, an input pin of the microprocessor 24 or the like detects a change in logical state and interprets this in a manner which will be detailed below. When input K is depressed, all of the diaphragms 20 are deformed resulting in closure of all of the mechanical contacts 22.

When the pressure on an input position 19 on the joy pad 18 is removed by the user, the deformed diaphragm 20 or diaphragms 20 restore to their original condition and return the joy pad 18 to a home position. In the home position, none of the diaphragms 20 are deformed and none of the contacts 22 are closed.

FIG. 7 schematically illustrates the contacts 22 of inputs A, B, C and D and their electrical connection to the microprocessor 24. Also shown located centrally of the joy pad 18 in this Figure, the contacts 22a, 22b for the first and second directional inputs. In this embodiment, the first and second directional inputs 22a, 22b are anti-clockwise and clockwise rotational inputs. As will be readily appreciated, each of the contacts 22 is connected between an electrical ground and the microprocessor 24. The microprocessor 24 includes an input pin which is arranged to sense a change in voltage across any of the contacts 22 when a contact 22 is closed. This change in voltage is interpreted by the microprocessor 24 as a change in logical state. The software that runs on the microprocessor 24 is triggered when a change of state is notified and the software in turn informs the operating system of the logical state change. The software of the operating system in turn channels the information to a software application which interprets the information so as to execute a corresponding or associated action.

As stated previously, the joy-dial 10 is mounted so that the user can apply limited rotational movement in either a clockwise or anti-clockwise direction about the z-axis to the joy pad 18. In order to activate either of the inputs I, J the user simply rotates the joy pad 18 using the thumb rails 30. During rotation of the joy pad 18, a stub or contact pad 26, as shown in FIG. 5, is engaged and is arranged to push against a biasing means 28 to close a corresponding contact 22a, 22b. The biasing means 28, preferably in the form of a spring, restores the joy pad 18 of the joy-dial 10 to the home position once the rotational force applied to the joy pad 18 by the user is removed.

The stub or contact pad 26 is, for example, fixedly attached to the joy pad 18 so that when the joy pad 18 is rotated, the stub 26 engages (or pushes against) the biasing means 28 to close the associated contact 22a, 22b. The associated contacts 22a, 22b may not necessarily comprise a diaphragm and may, for example, be a normal switch.

The rotation movement of the joy pad is typically about 45° in either the clockwise or anti-clockwise direction about a reference line extending between input positions A and C.

When the joy pad 18 is rotated in either a clockwise or anti-clockwise direction the inputs J, I are activated respectively. The rotational movement closes the associated contact 22a, 22b. As explained previously, when the contact 22a, 22b is closed, the resultant change in voltage across the contact 22a, 22b is detected by the input pin of the microprocessor 24. The software that runs on the microprocessor 24 recognises the change of voltage as being a change in logical state of the contact. The software informs the operating system of the logical state change, which in turn channels the information to a software application which interprets the information for executing a corresponding or an associated action. One use for the I and J inputs would be to control the volume or screen contrast of a device to which the joy-dial 10 is connected.

It will be appreciated by those skilled in the art that the method of equating the input applied to the joy-dial 10 by the user to an action by the micro processor 24 or the like may occur in a number of different ways. Similarly, the manner in which an input from the first and second directional inputs I, J is translated into an action by the microprocessor 24 or the like can also be varied.

FIG. 8 illustrates another embodiment of a joy-dial 200. The joy-dial 200 in accordance with this embodiment is constructed slightly differently to the joy-dial 10 shown in FIG. 5, although it works in a similar manner. The joy-dial 200 includes a base 216 and a joy pad 218. The base 216 includes a centrally located support 217 on which the joy pad 218 is arranged to be mounted. The support 217 is connected to the base 216 and is made from a firm non-compressible material. One suitable material for the support 217 is a polycarbonate material. The joy-dial 200 further includes diaphragms 220, contacts 222, a pair of contact stubs 226 and biasing means, in the form of a spring 228.

The joy pad 218 has a tapered peripheral edge 218a so that it can fit within a peripheral wall 216a of the base 216. The bottom face of the joy pad 218 contains a centrally located aperture or hollow 229 for receiving a top portion of the support 217. Located within the aperture or hollow 229 and connected to the joy pad 218 is an engaging member which is arranged to engage within an annular groove formed in the top surface of the support 217. In this manner the joy pad is able to turn in a clockwise or anticlockwise direction.

The base 216, support 217 and joy pad 218 are configured so that downward pressure applied to the joy pad 218 at marked input positions 219 causes the joy pad 218 to pivot about the support 217 so as to apply pressure to one or more of the diaphragms 220 located below the joy pad 218. The pressure applied to the diaphragms 220 causes them to deform so that an associated contact 222 is closed.

Rotational movement of the joy pad 218 about the centrally located support 217 causes the contact stubs 226 to engage against the spring 228 to close a corresponding contact 222a, 222b. Rotational movement is achieved by applying a “forward up” push or rotation to either of the thumb rails 230.

The spring 228 may adopt different shapes and may be wound around the support 217. The spring 228 must be shaped so that it contacts the stubs 226 when the joy pad 218 is rotated by the user.

The embodiment of the present invention is particularly advantageous because it enables an increased number of inputs to be available to the user. The additional degree of freedom of the joy-dial 10, 200 about the z-axis is particularly advantageous because of the extra input possibilities it provides.

An embodiment of the present invention is also advantageous because it reduces the space required for the user's input facility, while still maintaining and in fact increasing the number of possible inputs available for use by the user. This is achieved with minimal additional componentry thereby minimising any additional production costs. It is also believed that the described embodiment will have shorter electrical routing, which will thereby reduce electrical noise when the joy-dial 10, 200 is connected to a micro processor 24 or the like. This translates to a cleaner electrical signal which is an important criteria for most mobile devices.

It will also be appreciated that a joy-dial in accordance with an embodiment of the invention can be operated one-handed. Left or right hand control is possible.

While the embodiments described herein are preferred it will be appreciated from the specification that various alternatives, modifications, variations or improvements therein which may be made by those skilled in the art are within the scope of the invention, which is defined by the claims.

1. A joy-dial for providing input signals to a device, said joy-dial having a first and a second x-axis input position, a first and a second y-axis input position, and a first and a second directional input position, a joy pad, an elastically deformable diaphragm located below the joy pad corresponding to each of the x-axis and y-axis inputs, a contact located below and associated with each of the diaphragms and arranged so that pressure applied to the joy pad at one of the x- or a y-axis input positions results in deformation of the corresponding diaphragm and closure of the associated contact, and wherein the joy-dial further includes a first and a second directional contact, said first and second directional contacts being arranged so that they are closed upon movement of the joy-dial in a first or a second direction respectively.

2. A joy-dial according to claim 1 further including at least one diagonal input.

3. A joy-dial according to claim 2 having a diagonal input between each of the first y-axis and the second x-axis input, the second x-axis input and the second y-axis input, the second y-axis input and the first x-axis input and the first x-axis input and the first y-axis input.

4. A joy-dial according to claim 2 wherein pressure applied to a diagonal input position on the joy pad results in deformation of the associated diaphragms of the adjacent x- and y-axis inputs and closure of their associated contacts.

5. A joy-dial according to claim 1 further including a central input.

6. A joy-dial according to claim 5 wherein pressure applied to a central input position on the joy pad results in deformation of each of the diaphragms and closure of their associated contacts.

7. A joy-dial according to claim 1 further including an engagement means which is engaged during rotation of the joy pad and is arranged to push against a biasing means so as to close the associated first and second directional contact.

8. A joy-dial according to claim 7 wherein the biasing means restores the joy pad to a home position in which none of the contacts are closed once pressure applied by the user is removed.

9. A joy-dial according to claim 1 wherein movement of the joy-dial in the first or the second direction is achieved by respective clockwise and anti-clockwise rotation of the joy pad.

10. A joy-dial according to claim 1 wherein the joy pad can be rotated substantially 450 in either a clockwise or anti-clockwise direction about a z-axis.

11. A joy-dial according to claim 1 further including a base arranged for attachment to an information device or to a printed circuit board of a device and a cage means arranged to be connected to said base and to locate the joy pad there between.

12. A joy-dial according to claim 11 wherein a biasing means is located between the joy pad and an upper surface of the base.

13. A joy-dial according to claim 1 wherein the joy pad is marked to indicate the positioning of the input positions.

14. A joy-dial according to claim 1 wherein the joy pad has an upper surface which is patterned to enhance grip to the joy pad by the user's finger.

15. A joy-dial according to claim 1 wherein the joy pad is mounted for pivotal movement on a pivot means.

16. A joy-dial according to claim 15 wherein the joy pad includes an engaging member on an underside, said engaging member being arranged to engage within a groove formed in an upper surface of said pivot means.

17. A joy-dial according to claim 16 wherein the engaging member is located in a hollow or aperture formed in the underside of the joy pad.

18. A joy-dial according to claim 16 wherein the groove is annular so as to enable the joy pad to turn in a clockwise or anticlockwise direction.

19. A joy-dial according to claim 1 wherein the joy pad includes at least one thumb rail arranged to aid the user to rotate the joy pad.

20. An information device having at least one joy-dial, said joy-dial being arranged to provide input signals to the device, said joy-dial having a first and a second x-axis input position, a first and a second y-axis input position, and a first and a second directional input position, a joy pad, an elastically deformable diaphragm located below the joy pad corresponding to each of the x-axis and y-axis inputs, a contact located below and associated with each of the diaphragms and arranged so that pressure applied to the joy pad at one of the x- or a y-axis input positions results in deformation of the corresponding diaphragm and closure of the associated contact, and wherein the joy-dial further includes a first and a second directional contact, said first and second directional contacts being arranged so that they are closed upon movement of the joy-dial in a first or a second direction respectively.

21. A device according to claim 20 further including a microprocessor or the like which is arranged to detect closure of any of the contacts and to interpret such as a logical state change.

22. A device according to claim 20 further including an operating system which is arranged to be informed by the micro processor of a logical state change and to in turn inform a software application which interprets the information for executing a corresponding or an associated action.
